(19) United States
(12) Patent Application Publication
(10) Pub. No.: US 2017/0195723 A1
(43) Pub. Date: Jul. 6, 2017

(54) IMPROVEMENT TO GRAPHICAL USER INTERFACE (GUI) FOR UPDATING MULTIMEDIA OVER CABLE (MoCA)

(71) Applicant: THOMSON LICENSING, Issy Les Moulineaux (FR)

(72) Inventor: Chunzhi Michael William WANG, Carmel, IN (US)

(73) Assignee: Thomson Licensing, Issy les Moulineaux (FR)

(21) Appl. No.: 15/313,777

(22) PCT Filed: May 22, 2015
(86) PCT No.: PCT/US2015/032200

§ 371 Date: Nov. 23, 2016

Related U.S. Application Data
(60) Provisional application No. 62/008,795, filed on Jun. 6, 2014.

(51) Int. Cl. H04N 21/443; G06F 9/54; H04N 21/485; H04L 12/24; H04N 7/173

(52) U.S. Cl. CPC H04N 21/4432; H04L 41/08; H04N 21/4438; H04N 7/17318; H04N 21/485; H04L 12/24; G06F 9/542; H04N 21/443; G06F 2209/545

(57) ABSTRACT

A method and apparatus are described including accepting multimedia over cable parameters to be updated, saving the multimedia over cable parameters to a non-volatile memory, setting a flag, synchronizing parameters in the non-volatile memory with parameters used by a multimedia over cable chip with a multimedia over cable application programming interface and rebooting the multimedia over cable chip and initiating a background process. Also described are a method and apparatus for operating a background process including forwarding information for display on a multimedia over cable graphical user interface indicating a multimedia over cable chip is in transition, determining status of the multimedia over cable chip rebooting, clearing a flag if the multimedia over cable chip rebooting has completed and stopping the background process and returning to a normal state.

### CROSS REFERENCES

This application claims priority to a U.S. Provisional Application, Ser. No. 62/008,795, filed on Jun. 6, 2014, which is herein incorporated by reference in its entirety.

### FIELD

The proposed method and apparatus relates to improving the user interface and user experience when updating parameters in a gateway type device.

### BACKGROUND

This section is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

The problem of a graphical user interface (GUI) interface locking up upon initiation of an update is particularly an issue with certain manufacturers which require a complete reset of the function (e.g., Multimedia over Cable Alliance (MoCA)). MoCA is an industry standard alliance that develops technology for the connected home, such as but not limited to the ability to deliver high definition video and content. MoCA technology operates over existing in-home coaxial cabling. This problem may also apply to other functions such as Wi-Fi in the operation of a processor integrated circuit (IC) when parameters are modified. This MoCA reset (update, reconfiguration, modification) may take tens of seconds. During this time, the function is unavailable. The current arrangement also prevents the operation of the GUI during this time. The MoCA GUI or Simple Network Management Protocol (SNMP) Management Information Bases (MIBs) or other management tools like Tr69 will not be able to show (display) the ‘real’ parameters of the MoCA in this transition state. SNMP is a method by which network management applications can query a management agent using a supported MIB. SNMP operates at the application layer of the OSI model. The user is not shown a clear indication of status, and more importantly, the user cannot continue with other activities until the function reset (update, reconfiguration, modification) is complete.

### SUMMARY

A method and apparatus are described including accepting multimedia over cable parameters to be updated, saving the multimedia over cable parameters to a non-volatile memory, setting a flag, synchronizing parameters in the non-volatile memory with parameters used by a multimedia over cable chip with a multimedia over cable application programming interface and rebooting the multimedia over cable chip and initiating a background process. Also described are a method and apparatus for operating a background process including forwarding information for display on a multimedia over cable graphical user interface indicating a multimedia over cable chip is in transition, determining status of the multimedia over cable chip rebooting, clearing a flag if the multimedia over cable chip rebooting has completed and stopping the background process and returning to a normal state. Further described are a method and apparatus for operating a background process including accepting multimedia over cable parameters to be updated, saving the multimedia over cable parameters to a non-volatile memory and setting a flag, wherein the flag is a second flag.

Also described are a method and apparatus including accepting multimedia over cable parameters to be updated, saving the multimedia over cable parameters to a non-volatile memory, setting a first flag, synchronizing parameters in the non-volatile memory with parameters used by a multimedia over cable chip with a multimedia over cable application programming interface, forwarding the updated parameters and information for display on a multimedia over cable graphical user interface indicating a multimedia over cable chip is in transition, rebooting the multimedia over cable chip and initiating a background process, clearing a second flag, determining status of the multimedia over cable chip rebooting, clearing the first flag if the multimedia over cable chip rebooting has completed, determining if the second flag is set, stopping the background process and returning to a normal state, if the second flag is set and clearing the first flag.

### BRIEF DESCRIPTION OF THE DRAWINGS

The proposed method and apparatus is best understood from the following detailed description when read in conjunction with the accompanying drawings. The drawings include the following figures briefly described below:

FIG. 1 is an exemplary MoCA GUI before initiation of a MoCA update.

FIG. 2 is an exemplary MoCA GUI during a MoCA update.

FIG. 3 is an exemplary MoCA GUI after a MoCA update has completed.

FIG. 4 is a block diagram of an exemplary apparatus, such as a set top box, which operates in accordance with the principles of the proposed method.

FIG. 5A is a MoCA management diagram of an apparatus such as a set top box (based on FIG. 4) and which operated as before the proposed method.

FIG. 5B is a MoCA management diagram of an exemplary apparatus such as a set top box (based on FIG. 4) and which operates in accordance with the principles of the proposed method.

FIG. 6 is a flowchart of the operation of an exemplary MoCA in a normal state in accordance with the principles of the proposed method.

FIG. 7 is a flowchart of the operation of an exemplary background process while the exemplary MoCA is in a transition state in accordance with the principles of the proposed method.

FIG. 8 is a flowchart of the operation of an alternative exemplary MoCA in a normal state in accordance with the principles of the proposed method.

FIG. 9 is a flowchart of the operation of an alternative exemplary MoCA in a transition state in accordance with the principles of the proposed method.

FIG. 10 is a flowchart of the operation of an alternative exemplary MoCA in a transition state in accordance with the principles of the proposed method.

It should be understood that the drawing(s) are for purposes of illustrating the concepts of the disclosure and is not necessarily the only possible configuration for illustrating the disclosure.

### DETAILED DESCRIPTION

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The proposed method may apply to any product that uses a GUI or MIB based control mechanism for operation. Primary examples are gateway devices that include MoCA and/or WI-FI and use a GUI for operating parameter changes (e.g., TG8717C and TG81717T). The operation of the proposed method is controlled by control code usually in a processor inside the device such as a “system on a chip” or SoC.

An example of the operation of the process for MoCA is provided below. MoCA can be set/configured/reset/reconfigured by:

1) configuration file at start up—by operator

2) SNMP MIB change—by operator

3) User GUI change—by user

4) Multi-system Operator (MSO) GUI change—by operator

5) Tr69—by operator

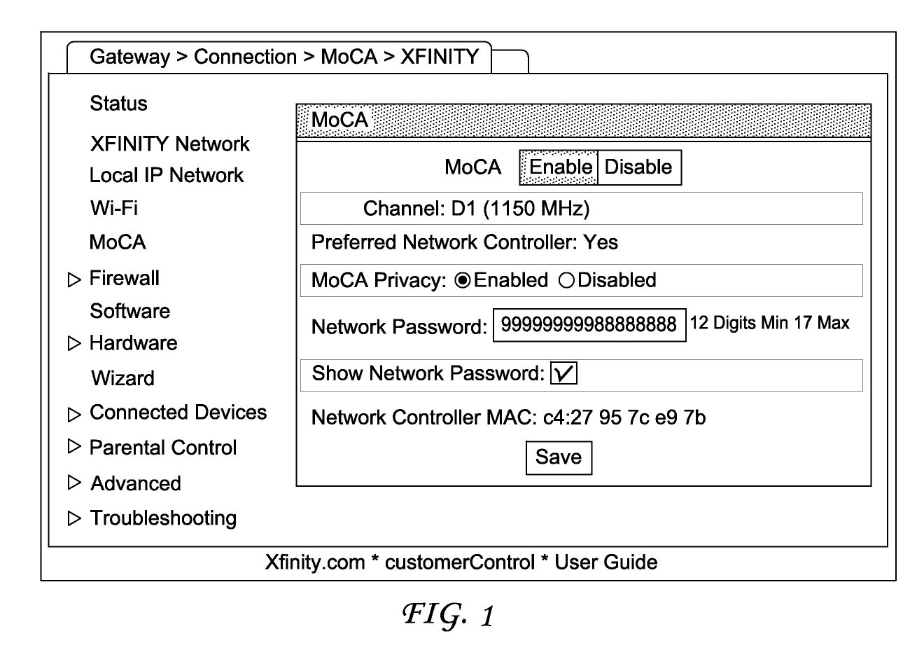

FIG. 1-FIG. 3 show the sequence of changing MoCA parameters by a user using the proposed GUI. It should be noted that an operator may also change (update, reconfigure, modify) MoCA parameters using any other mentioned methods. The screen shot of FIG. 1 shows the initial screen before changing MoCA parameters using this GUI. In this example, the user only changes (updates, reconfigures, modifies) the network password from the GUI. When parameters are changed (updated, reconfigured, modified) by the user and the user presses the ‘SAVE’ button, the update begins.

Internally, all the parameter are saved to non-volatile memory and the MoCA software then proceeds to reconfigure (update, change, modify), the MoCA device and initiate monitoring of the update (reconfiguration, modification) process.

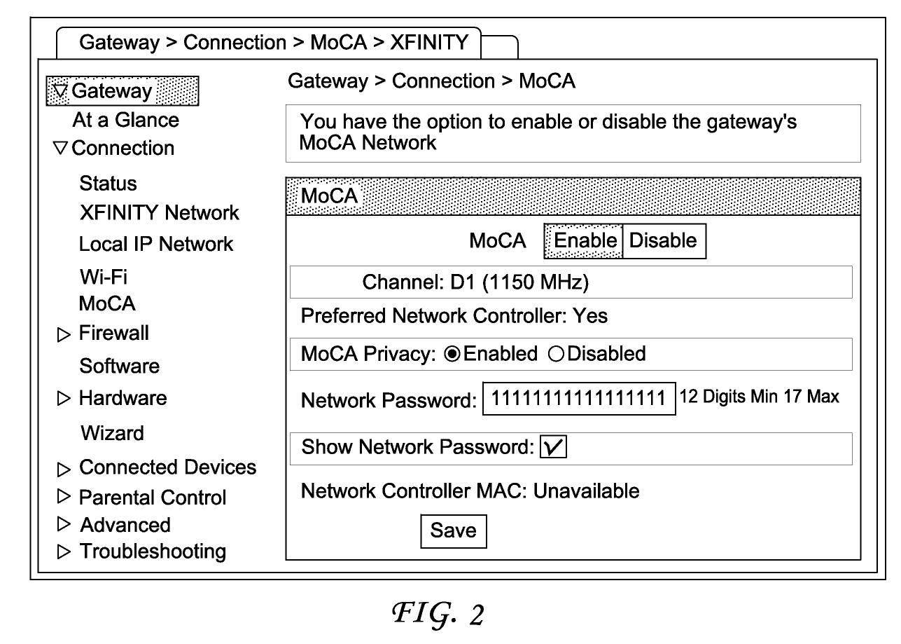

In the example shown in FIG. 2, user has changed the MoCA password and pressed the ‘SAVE’ button. In order to improve the user experience, as mentioned above, all the MoCA parameters are stored in non-volatile memory. Ideally all parameters/status should be obtained by querying the MoCA device to ensure that the real parameters are being used and the current device status is known. However, some parameters will be very unlikely to be changed. The unchanged parameter values can be retrieved from non-volatile memory and will be displayed on the GUI during the monitoring process. As shown in the GUI, network password should be unchanged after it is set, so the set password is displayed in the GUI when MoCA is resetting. The user can, therefore, clearly view the unchanged parameter value(s) on the GUI display during the monitoring process. For the parameter values that need to be read by querying the MoCA device, the MoCA GUI will display an indicator reminding the user that MoCA is in transition state. This also serves to advise the user that the MoCA is not responsive and will not be responsive until the reconfiguration is complete. in the sample MoCA GUI shown in FIG. 2, the ‘Network Controller MAC’ field is displayed as ‘Unavailable’. Other options including (but are not limited to) ‘Temporarily unavailable . . . ’, ‘Acquiring . . . ’, or the like are possible, all of which serve to indicate to the user that the MoCA GUI is in a transition state.

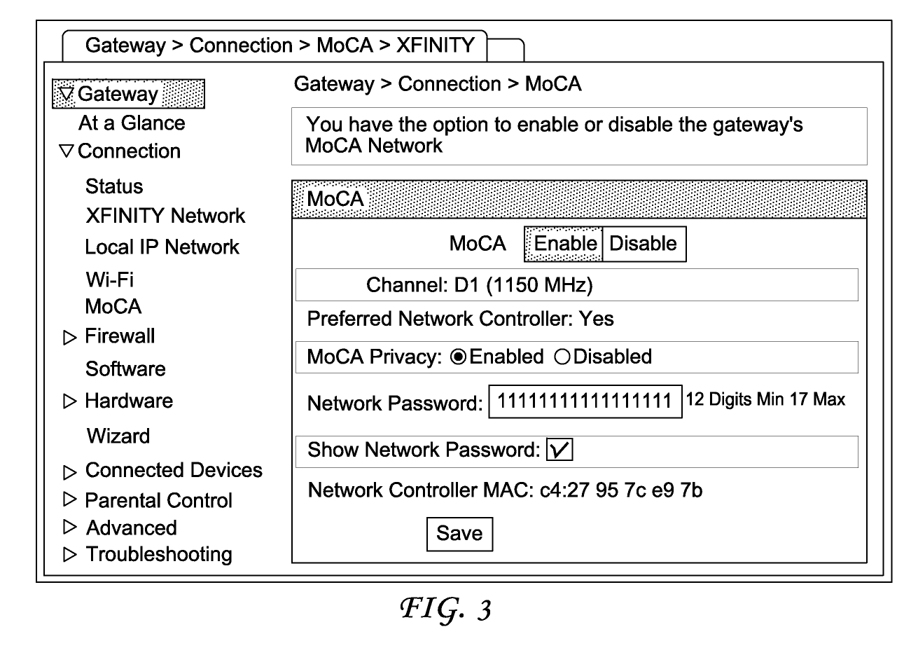

When the MoCA is in the transition state, the user can modify (update, reconfigure) the MoCA parameters from GUI again, he/she can also navigate to other screens and continue updating (changing) parameters for other functions. After the MoCA parameter reconfiguration (update, modification) process has completed and MoCA becomes stable, the MoCA GUI will display as normal as shown in FIG. 3. This MoCA GUI update (reconfiguration, modification) could be done automatically or by the user, but all MOCA updates are based on the transition/stable check result by the internal monitor process started during reconfigure (update, modification) process. The details of the internal monitoring process will be described below.

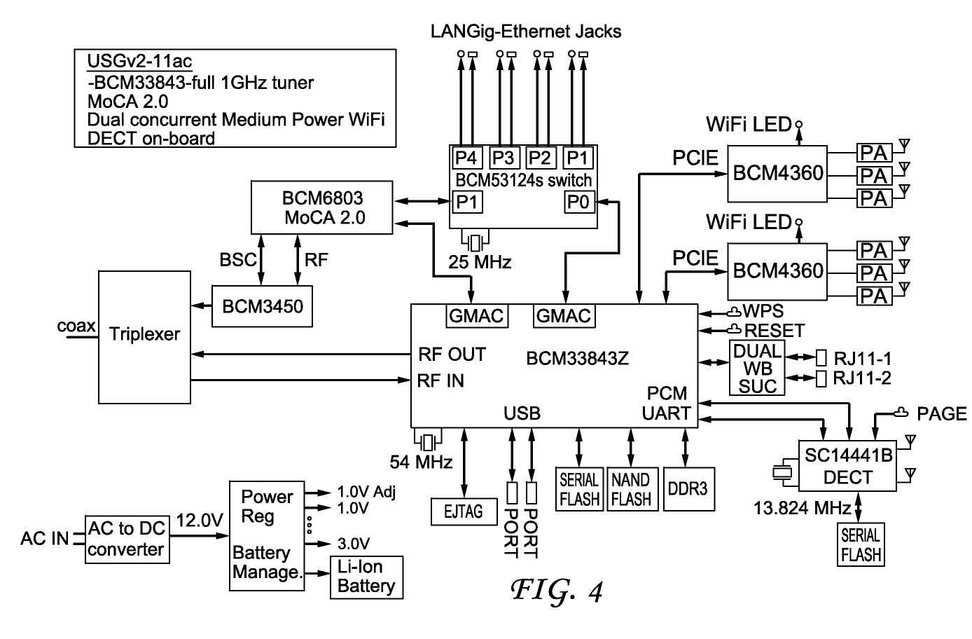

FIG. 4 is a block diagram of an exemplary set top box (STB) in accordance with the principles of the proposed method and apparatus. If a user or an operator wants to reconfigure (update, modify) the MoCA device via the MoCA GUI using a display device (which is not part of the set top box (STB)) which may be local to the STB or remote from the STB, the user or operator accesses the MoCA (BCM 6803) via the BCM 33843Z (SoC, processor). This may be accomplished over a WAN connection through the Triplexer as RF in using a cable modem (not shown) in the SoC (BCM33843Z, processor) or by either WiFi band 1 or WiFi band 2 (through BCM 4360) or through one of the four LAN connections (with BCM 53124s switch). The MoCA GUI is displayed on the display device by a web site. That is, the user or operator accesses a web site which accesses the MoCA (BCM 6803) as described above, the SoC (processor, BCM 33843Z) has the control codes to actually direct the MoCA (BCM 6803) to perform the requested functions, e.g., reconfigure (update, modify) the MoCA (BCM 6803).

Once a MoCA (BCM 6803) reconfigure (update, modify) command is initiated, the parameters associated with the command are saved to (stored in) non-volatile memory. This non-volatile memory is, for example, the NAND chip on the board (NAND Flash 128M). These parameters will be used by MoCA device (chip BCM6803 MoCA 2.0).

A flag is then set to indicate that the MoCA is in a transition state and further parameter reading from MoCA device is not available. Then parameters in non-volatile memory and parameters used by MoCA chip are synchronized through the MoCA driver (which is a set of software functions running on main CPU (not on the MoCA chip). The software bridges the main CPU and the MoCA chip) This is necessary, otherwise, the parameters saved to non-volatile memory will not be retrieved and used by the MoCA device. MoCA reboot is initiated and a background process to monitor the MoCA reboot is started. As soon as the flag is set, the MoCA GUI display will be based on whether this item will be changed or not after it is set, as described before. An exemplary MoCA GUI appears as shown in FIG. 2 (in a transition state).

The background process first checks the MoCA status after a first period of time, for example, 20 seconds). If the MoCA reboot has not completed, the background process checks the MoCA periodically, for example, every 10 seconds, and continues to check the MoCA periodically. Once the MoCA reboot has completed and MoCA is stable then the first flag is cleared and the background process is stopped. The MoCA parameters and status can be and are read from the MoCA device. The updated MoCA parameters are used to refresh the MoCA GUI for automatic update or when the user or operator navigates to the MoCA GUI. An exemplary updated MoCA GUI is as shown in FIG. 3.

While the MoCA is rebooting the user or operator can navigate to other pages or very importantly can further change MoCA parameters. If the user or operator wants to further change MoCA parameters, he/she can enter the parameters that he/she wants to change on the MoCA GUI transition screen and press ‘SAVE’ button (changes of parameters will only take effect after ‘SAVE’ button is pressed, one ‘SAVE’ press is considered as a parameter change and can change several parameters at one time). The parameters that the user or operator wants to change will be saved to non-volatile memory. Once the MoCA has finished rebooting, The second reconfiguration (update. modification) of the MoCA with new parameters begins. All the parameter changes have to be executed sequentially.

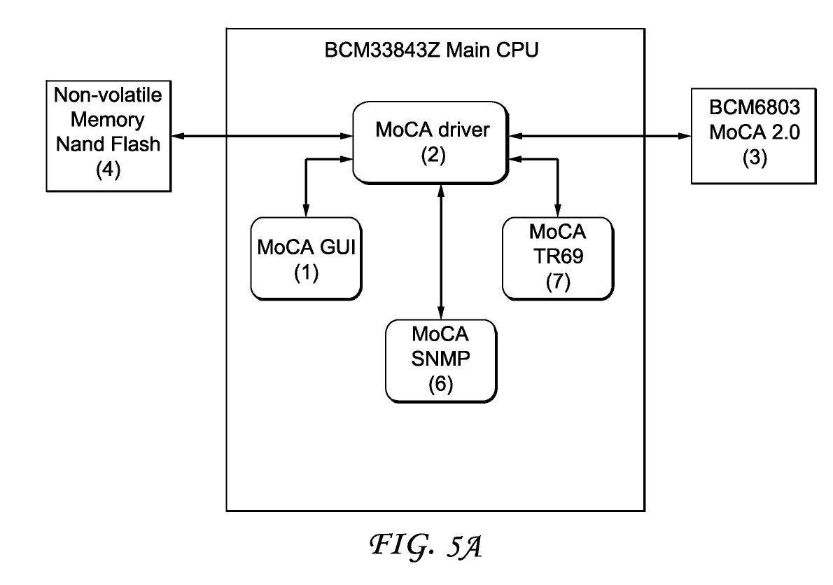

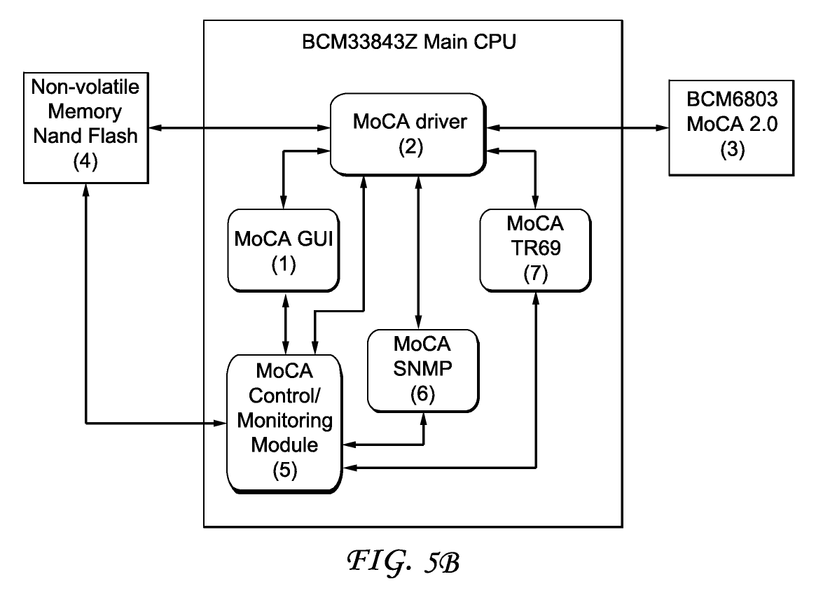

FIG. 5A is a MoCA management diagram of an apparatus such as a set top box (based on FIG. 4) and which operated as before the proposed method. The squared modules on FIG. 5A are hardware (chips) and the modules with rounded edges are software modules. When a parameter change was necessary or desirable, the user initiated a parameter change (update, reconfiguration) from the MoCA GUI (1) through the MoCA driver (2). The MoCA Driver (2) saved (stored) the parameters to the non-volatile memory (NAND Flash (4)) and also updated the MoCA device (BCM6803 MoCA 2.0 (3)). The MoCA driver (2) then rebooted the chip (BCM6803 MoCA 2.0 (3)). Any further read/write functions from the MoCA GUI (1) through the MoCA driver (2) were not responsive until BCM6803 MoCA 2.0 (3) had finished rebooting. If the user or operator attempted to further update MoCA parameters during MoCA reboot, the MoCA GUI would try to retrieve MoCA data through the MoCA driver (2) but the MoCA driver (2) could not “talk” to the BCM MoCA 2.0 (3) while the BCM6803 MoCA 2.0 (3) was being rebooted. Thus, the user or operator would feel like the MoCA GUI was frozen. Further MoCA parameter updates could be made upon completion of the MoCA (BCM6803 MoCA 2.0 (3)) reboot.

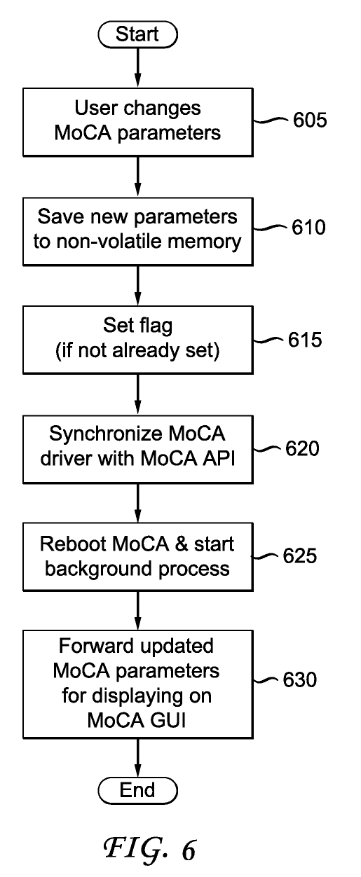

FIG. 5B is a MoCA management diagram of an exemplary apparatus such as a set top box (based on FIG. 4) and which operates in accordance with the principles of the proposed method. The squared modules on FIG. 5B are hardware (chips) and the modules with rounded edges are software modules. The control flow as it is in the proposed method is shown in FIG. 6-10 and described below.

FIG. 6 is a flowchart of the operation of an exemplary MoCA in a normal state in accordance with the principles of the proposed method. At 605 a user enters the changes the MoCA parameters on a GUI such as shown on FIG. 1. At 610 the updated MoCA parameters together with other parameters are saved (stored) to non-volatile memory. At 615 a flag is set (if the flag is not already set). The flag indicates that the user has initiated a MoCA parameter reconfiguration and the set top box is in a transition state. Then at 620 parameters in non-volatile memory and parameters used by MoCA chip are synchronized through the MoCA driver with the MoCA API (which is a set of software functions running on main CPU). The software bridges the main CPU and the MoCA chip. This is necessary otherwise, the parameters saved to non-volatile memory will not be retrieved and used by the MoCA device. At 625 the MoCA reboot is initiated and the background process is started. While the reboot is running the user is able to navigate to other pages or even request additional MoCA parameter updates (reconfigurations, modifications). When the reboot is complete (if no other MoCA parameter updates have been initiated, requested), control is returned to 630 which indicates that parameters/status can be retrieved from MoCA device and forwards the updated (reconfigured, modified) parameters for displaying on the MoCA GUI (e.g., FIG. 3). That is, referring back to FIG. 5, the user or operator initiates a parameter change from the MoCA GUI (1) and control passes through the MoCA control/monitoring process (5) to save (store) the parameters to be updated in the non-volatile memory (NAND Flash (4)). The MoCA control/monitoring module (5) then sets the flag and passes control to the MoCA driver (2) which retrieves the parameters to be updated (reconfigured, modified) from the non-volatile memory (NAND Flash (4)) and also updated the MoCA device (BCM6803 MoCA 2.0 (3)). Then MoCA driver (2) reboots the chip (BCM6803 MoCA 2.0 (3)). The MoCA monitoring module (5) keeps monitoring the MoCA chip resetting process by polling the status of the MoCA chip (BCM6803 MoCA 2.0 (3)) through the MoCA Driver (2). Once MoCA monitoring module (5) detects that the MoCA resetting has finished and the MoCA is stable, the MoCA monitoring module will clear the flag, so MoCA GUI (1) can retrieve parameters from MoCA chip (BCM6803 MoCA 2.0 (3)) through the MoCA driver (2)

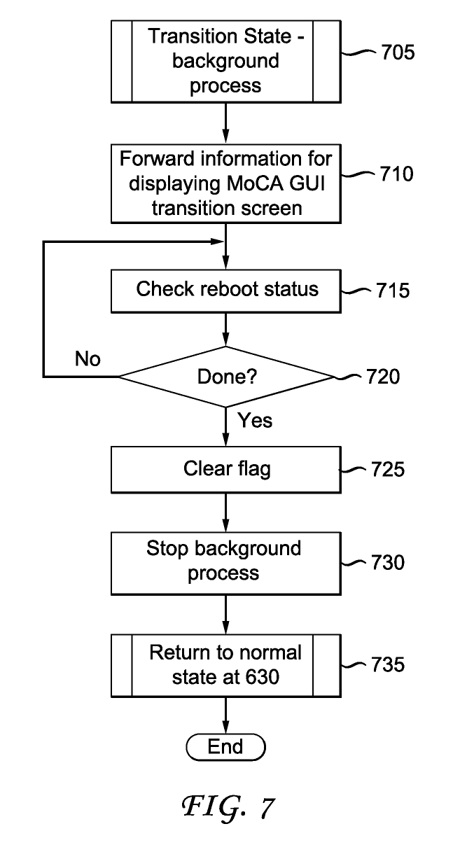

FIG. 7 is a flowchart of the operation of an exemplary background process while the exemplary MoCA is in a transition state in accordance with the principles of the proposed method. At 705 the background process (while the MoCA is in a transition state) has been initiated. At 710 information for displaying the MoCA transition screen (FIG. 2) are forwarded to the MoCA GUI. At 715 the MoCA reboot status is checked. At 720 a test is performed to determine if the MoCA reboot has completed. If the MoCA reboot has not competed then processing proceeds to 715. If the MoCA reboot has completed then at 725 the flag is cleared and at 730 the background process is stopped. At 735 the background process returns to the normal state at 630 of FIG. 6.

If parameters are modified while the MoCA is rebooting (in the transition state) and the MoCA needs to be reconfigured (updated, modified) again then wait for the first reconfiguration (update, modification) to finish, then start the second reconfiguration (update. modification) immediately. Once the first (initial) MoCA reboot has completed, the background process determines if further parameter updates (modifications, reconfigurations) are needed by checking the non-volatile memory for further saved (stored) parameters have been changed. This is relatively fast since there are only about ten parameters that a user or operator can or would change. The further MoCA parameter updates made by the user through the MoCA GUI (1) are forwarded to the MoCA control/monitoring module and saved to (stored in) non-volatile memory (NAND Flash (4) and upon completion of the previously initiated MoCA (BCM MoCA 2.0 (3)) reboot, the further MoCA parameter update in immediately initiated.

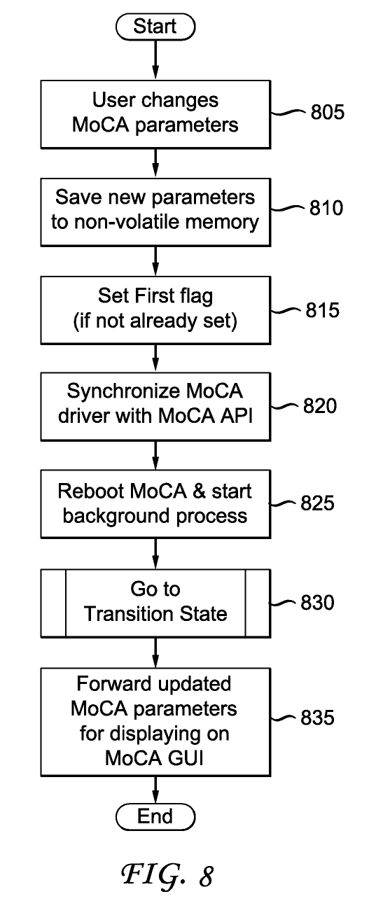

FIG. 8 is a flowchart of the operation of an alternative exemplary MoCA in a normal state in accordance with the principles of the proposed method. At 805 a user enters the changes the MoCA parameters on a GUI such as shown on FIG. 1. At 810 the updated MoCA parameters together with other parameters are saved (stored) to non-volatile memory. At 815 a first flag is set (if the flag is not already set). The flag indicates that the user has initiated a MoCA parameter reconfiguration and the set top box is in a transition state. Then at 820 parameters in non-volatile and parameters used by MoCA chip are synchronized through the MoCA driver with the MoCA API (which is a set of software functions running on main CPU). The software bridges the main CPU and the MoCA chip. This is necessary otherwise, the parameters saved to non-volatile memory will not be retrieved and used by the MoCA device. At 825 the MoCA reboot is initiated and the background process is started. At 835 the MoCA goes into the transition state. While the reboot is running the user is able to navigate to other pages or even request additional MoCA parameter updates (reconfigurations, modifications). When the reboot is complete (if no other MoCA parameter updates have been initiated, requested), control is returned to 835 which indicates that parameters/status can be retrieved from MoCA device and forwards the updated (reconfigured, modified) parameters for displaying on the MoCA GUI (e.g., FIG. 3). That is, referring back to FIG. 5, the user or operator initiates a parameter change from the MoCA GUI (1) and the MoCA control/monitoring process (5) saves (stores) the parameters to be updated in the non-volatile memory (NAND Flash (4)). The MoCA control/monitoring module (5) then sets the flag and the MoCA driver (2) retrieves the parameters to be updated (reconfigured, modified) from the non-volatile memory (NAND Flash (4)). Control then passes to BCM6803 MoCA 2.0 (3) to reboot the MoCA. When the parameter update (reconfiguration, modification) is complete then control is passed to the MoCA control/monitoring module through the MoCA driver (2) so that the flag can be cleared by the background process.

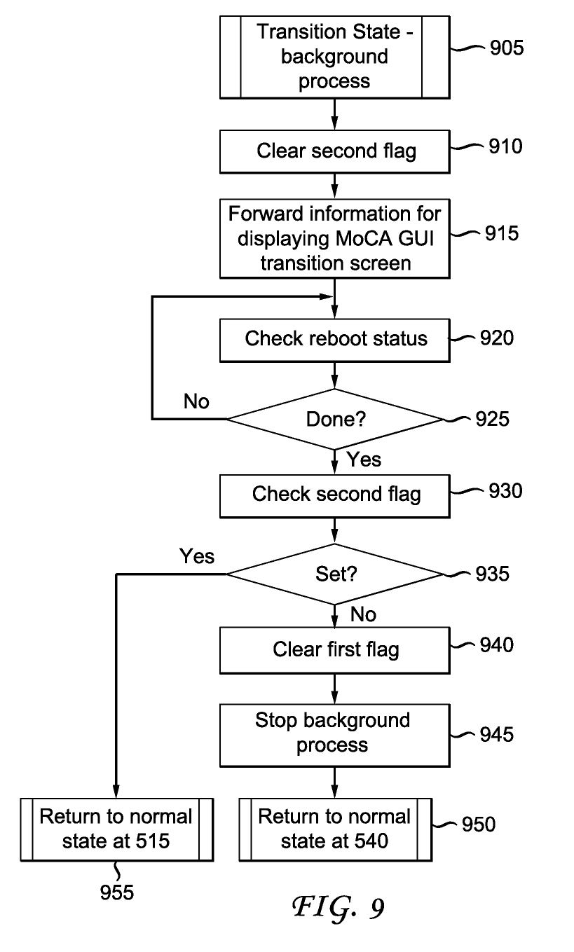

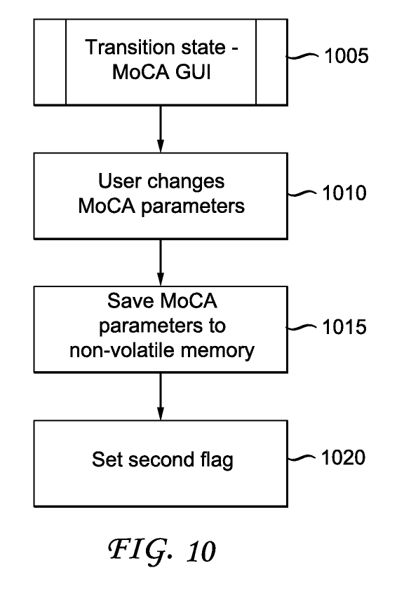

FIG. 9 is a flowchart of the operation of an alternative exemplary MoCA in a transition state in accordance with the principles of the proposed method. At 905 the transition state (background process) is entered. At 910 the second flag is cleared. The second flag is used to indicate that the user has entered additional MoCA parameters to change while the MoCA is in the transition state (and rebooting). At 915 the transition information is forwarded for displaying on the MoCA GUI (e.g., FIG. 2). At 920 the status of the MoCA reboot is checked. At 925 a test is performed to determine if the MoCA reboot has completed. If the MoCA reboot has not completed then processing returns to 920. If the MoCA reboot has completed then at 930 the second flag is checked. At 935 a test is performed to determine if the second flag is set. If the second flag is not set then at 940 the first flag is cleared. At 945 the background process is stopped (halted) and at 950 control is returned to the normal state (FIG. 8) at 835. If the second flag is set then control is returned to the normal state (FIG. 8) at 815 so that processing for the further updated (reconfigured, modified) MoCA parameters can be handled. That is, in the alternative embodiment, the determination if further parameters have been updated (modified, reconfigured) is determined by the setting of a second flag. This is shown in FIG. 10.

FIG. 10 is a flowchart of the operation of an alternative exemplary MoCA in a transition state in accordance with the principles of the proposed method. The functionality in FIG. 10 occurs during 920 and 925 of FIG. 9. At 1005 the MoCA GUI is in the transition state. At 1010 the user has used the MoCA GUI to further update (reconfigure, modify) MoCA parameters. At 1015 the further updated (reconfigured, modified) MoCA parameters are saved (stored) to non-volatile memory (storage) and at 1020 the second flag is set to indicate that the user has further updated (reconfigured, modified) the MoCA parameters and that the process needs to begin anew starting at 815 to handle the further updated (reconfigured, modified) MoCA parameters.

By using the proposed method, users will not have to be delayed (or get stuck or get locked or be frozen) in the MoCA GUI upon initiating a MoCA parameter change (reconfigure, modify). The user can navigate the GUI or change MoCA parameters again. The user does not have to wait for the MoCA updates to become stable. The MoCA GUI in transition state will show ‘Unavailable’ for some item(s) to the user so he/she will know that the MoCA is in a transition state. While in a transition state, the user can modify the parameters as normal but the MoCA GUI will be displayed as in a transition state. If additional MoCA GUI parameters are modified (updated, reconfigured) while the MoCA GUI is in a transition state then the MoCA parameters are saved to an additional non-volatile memory (storage) area and when the MoCA becomes stable, an additional MoCA update will be initiated automatically. In the alternative, while the MoCA is in a transition state, if additional MoCA GUI parameters are modified (updated, reconfigured) the latest MoCA parameters could be retrieved from non-volatile memory and the MoCA update continue until all the updates are complete. The MoCA GUI would be displayed as in a transition state until all updates have been completed and the MoCA is stable.

It is to be understood that the proposed method and apparatus may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the proposed method and apparatus is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

It is to be further understood that, because some of the constituent system components and method steps depicted in the accompanying figures are preferably implemented in software, the actual connections between the system components (or the process steps) may differ depending upon the manner in which the proposed method and apparatus is programmed. Given the teachings herein, one of ordinary skill in the related art will be able to contemplate these and similar implementations or configurations of the proposed method and apparatus.

1. A method, said method comprising:
accepting multimedia over cable parameters to be updated;
saving said multimedia over cable parameters to a non-volatile memory;
setting a flag;
synchronizing parameters in said non-volatile memory with parameters used by a multimedia over cable chip with a multimedia over cable application programming interface; and
rebooting said multimedia over cable chip and initiating a background process.

2. The method according to claim 1, further comprising forwarding said updated parameters for display on a multimedia over cable graphical user interface.

3. The method according to claim 1, wherein said flag is a first flag.

4. A method for operating a background process, said method comprising:
forwarding information for display on a multimedia over cable graphical user interface indicating a multimedia over cable chip is in transition;
determining status of said multimedia over cable chip rebooting;
clearing a flag if said multimedia over cable chip rebooting has completed; and
stopping said background process and returning to a normal state.

5. The method according to claim 4, further comprising:
clearing a second flag;
determining if said second flag is set;
returning to a normal state if said second flag is set; and
clearing said flag, wherein said flag is a first flag.

6. A method for operating a background process, said method comprising:
accepting multimedia over cable parameters to be updated;
saving said multimedia over cable parameters to a non-volatile memory; and
setting a flag.

7. An apparatus, comprising:
a multimedia over cable graphical user interface, said multimedia over cable graphical user interface accepting multimedia over cable parameters to be updated;
said multimedia over cable graphical user interface saving said multimedia over cable parameters to a non-volatile memory through a multimedia over cable driver, said multimedia over cable graphical user interface in bi-directional communication with said multimedia over cable driver, said multimedia over cable driver in bi-directional communication with said non-volatile memory;
a multimedia over cable monitoring module, said multimedia over cable monitoring module setting a flag, said multimedia over cable monitoring module in bi-directional communication with said multimedia over cable driver, said multimedia over cable monitoring module in bi-directional communication with said multimedia over cable graphical user interface;
a multimedia over cable application programming interface, said multimedia over cable application programming interface synchronizing parameters in said non-volatile memory with parameters used by a multimedia over cable chip, said multimedia over cable application programming interface being executed on a processor; and
said multimedia over cable monitoring module initiating rebooting of said multimedia over cable chip through said multimedia over cable driver and said multimedia over cable monitoring module initiating a background process.

8. The apparatus according to claim 7, further comprising said multimedia over cable monitoring module forwarding said updated parameters for display on a multimedia over cable graphical user interface.

9. The apparatus according to claim 7, wherein said flag is a first flag.

10. An apparatus for operating a background process, comprising:
a multimedia over cable monitoring module, said multimedia over cable monitoring module forwarding information for display on a multimedia over cable graphical user interface indicating a multimedia over cable chip is in transition;
said multimedia over cable monitoring module determining status of said multimedia over cable chip rebooting;
said multimedia over cable monitoring module clearing a flag if said multimedia over cable chip rebooting has completed; and
said multimedia over cable monitoring module stopping said background process and returning to a normal state.

11. The apparatus according to claim 10, further comprising:
said multimedia over cable monitoring module clearing a second flag;
said multimedia over cable monitoring module determining if said second flag is set;
said multimedia over cable monitoring module returning to a normal state if said second flag is set; and
said multimedia over cable monitoring module clearing said flag, wherein said flag is a first flag.

12. An apparatus for operating a background process, comprising:
a multimedia over cable graphical user interface, said multimedia over cable graphical interface accepting multimedia over cable parameters to be updated;
said multimedia over cable graphical user interface saving said multimedia over cable parameters to a non-volatile memory through a multimedia over cable driver, said multimedia over cable graphical user interface in bi-directional communication with said multimedia over cable driver, said multimedia over cable driver in bi-directional communication with said non-volatile memory; and
a multimedia over cable monitoring module, said multimedia over cable monitoring module setting a flag, said multimedia over cable monitoring module in bi-directional communication with said multimedia over cable driver, said multimedia over cable monitoring module in bi-directional communication with said multimedia over cable graphical user interface.

13. An apparatus, comprising:
means for accepting multimedia over cable parameters to be updated;
means for saving said multimedia over cable parameters to a non-volatile memory;
means for setting a flag;
means for synchronizing parameters in said non-volatile memory with parameters used by a multimedia over cable chip with a multimedia over cable application programming interface; and
rebooting said multimedia over cable chip and initiating a background process.

14. The apparatus according to claim 13, further comprising means for forwarding said updated parameters for display on a multimedia over cable graphical user interface.

15. The apparatus according to claim 13, wherein said flag is a first flag.

16. An apparatus for operating a background process, comprising:
means for forwarding information for display on a multimedia over cable graphical user interface indicating a multimedia over cable chip is in transition;
means for determining status of said multimedia over cable chip rebooting;
means for clearing a flag if said multimedia over cable chip rebooting has completed; and
means for stopping said background process and returning to a normal state.

17. The apparatus according to claim 16, further comprising:
means for clearing a second flag;
means for determining if said second flag is set;
means for returning to a normal state if said second flag is set; and
means for clearing said flag, wherein said flag is a first flag.

18. An apparatus for operating a background process, comprising:
means for accepting multimedia over cable parameters to be updated;
means for saving said multimedia over cable parameters to a non-volatile memory; and
means for setting a flag.

19. A method, said method comprising:
accepting multimedia over cable parameters to be updated;
saving said multimedia over cable parameters to a non-volatile memory;
setting a first flag;
synchronizing parameters in said non-volatile memory with parameters used by a multimedia over cable chip with a multimedia over cable application programming interface;
forwarding said updated parameters and information for display on a multimedia over cable graphical user interface indicating a multimedia over cable chip is in transition;
rebooting said multimedia over cable chip and initiating a background process;
clearing a second flag;
determining status of said multimedia over cable chip rebooting;
clearing said first flag if said multimedia over cable chip rebooting has completed;
determining if said second flag is set;
stopping said background process and returning to a normal state, if said second flag is set; and
clearing said first flag.

20. An apparatus comprising:
means for accepting multimedia over cable parameters to be updated;
means for saving said multimedia over cable parameters to a non-volatile memory;
means for setting a first flag;
means for synchronizing parameters in said non-volatile memory with parameters used by a multimedia over cable chip with a multimedia over cable application programming interface;
means for forwarding said updated parameters and information for display on a multimedia over cable graphical user interface indicating a multimedia over cable chip is in transition;
means for rebooting said multimedia over cable chip and initiating a background process;
means for clearing a second flag;
means for forwarding information for display on a multimedia over cable graphical user interface indicating a multimedia over cable chip is in transition;
means for determining status of said multimedia over cable chip rebooting;
means for clearing said first flag if said multimedia over cable chip rebooting has completed;
means for determining if said second flag is set;
means for stopping said background process and returning to a normal state, if said second flag is set; and
means for clearing said first flag.

21. An apparatus, comprising:
a multimedia over cable graphical user interface, said multimedia over cable graphical user interface accepting multimedia over cable parameters to be updated;
said multimedia over cable graphical user interface saving said multimedia over cable parameters to a non-volatile memory through a multimedia over cable driver, said multimedia over cable graphical user interface in bi-directional communication with said multimedia over cable driver, said multimedia over cable driver in bi-directional communication with said non-volatile memory;
a multimedia over cable monitoring module, said multimedia over cable monitoring module setting a first flag, said multimedia over cable monitoring module in bi-directional communication with said multimedia over cable driver, said multimedia over cable monitoring module in bi-directional communication with said multimedia over cable graphical user interface;
a multimedia over cable application programming interface, said multimedia over cable application programming interface synchronizing parameters in said non-volatile memory with parameters used by a multimedia over cable chip, said multimedia over cable application programming interface being executed on a processor;
said multimedia over cable monitoring module forwarding said updated parameters for display on a multimedia over cable graphical user interface;
said multimedia over cable monitoring module initiating rebooting of said multimedia over cable chip through said multimedia over cable driver and said multimedia over cable monitoring module initiating a background process;
said multimedia over cable monitoring module clearing a second flag;
said multimedia over cable monitoring module determining status of said multimedia over cable chip rebooting;
said multimedia over cable monitoring module clearing said first flag if said multimedia over cable chip rebooting has completed;
said multimedia over cable monitoring module determining if said second flag is set; and
said multimedia over cable monitoring module stopping said background process and returning to a normal state if said second flag is set.
